(19) United States
(12) Patent Application Publication
(10) Pub. No.: US 2022/0114477 A1
(43) Pub. Date: Apr. 14, 2022

(54) EVENT DRIVEN CONFIGURABLE ARTIFICIAL INTELLIGENCE WORKFLOW

(71) Applicant: Baidu USA LLC, Sunnyvale, CA (US)

(72) Inventors: Haofeng KOU, Sunnyvale, CA (US); Yueqiang CHENG, Sunnyvale, CA (US)

(21) Appl. No.: 17/070,786

(22) Filed: Oct. 14, 2020

(51) Int. Cl. G06N 20/00; G06N 5/04; G06F 9/46; G06K 9/00

(52) U.S. Cl. CPC G06N 20/00; G06N 5/04; G06K 2209/23; G06K 9/00228; G06K 2009/00322; G06F 9/466

(57) ABSTRACT

In one embodiment, in response to sensor data received from a sensor device of a detection device, an analysis is performed on the sensor data within the detection device. Configuration data is determined based on the analysis of the sensor data. The configuration data identifies one or more actions to be performed. Each action is associated with a particular artificial intelligence (AI) model. For each of the actions, an event is generated to trigger the corresponding action to be performed. In response to each of the events, an AI model corresponding to the action associated with the event is executed. The AI model is applied to at least a portion of the sensor data to classify the sensor data.

### TECHNICAL FIELD

Embodiments of the present disclosure relate generally to processing of sensor data by multiple artificial intelligence (AI) models. More particularly, embodiments of the disclosure relate to event driven configurable AI model.

### BACKGROUND

Computer vision and AI models may be used in several scenarios in which multiple AI models are used to perform several related tasks. For example, several models, such as deep neural networks (DNN) models, may be used to identify an object and to detect several attributes about the object. However, several applications that utilize several AI models may be limited by availability of computer hardware. For example, in smart camera applications or autonomous driving vehicles adding additional hardware to execute an additional AI model may be prohibitively costly. Upgrading the system with more powerful computational hardware may also add cost and may introduce other compatibility issues and require significant software updates. Applications may be executed in several separate functional modules in parallel. However, executing the applications in parallel in separately programmed functional modules may slow down all applications executing on the system.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2A is a block diagram illustrating an example of a detection device according to one embodiment.

FIG. 2B is a block diagram illustrating a data structure storing configuration data according to one embodiment.

FIG. 3 is a block diagram illustrating an example process flow for an event driven configurable AI workflow according to one embodiment.

FIG. 4A-4B is a block diagram illustrating an example of an event driven configurable AI workflow according to one embodiment.

FIG. 5 is a flow diagram illustrating an example method for an event driven configurable AI workflow according to one embodiment.

FIG. 6 is a flow diagram illustrating another example method for an event driven configurable AI workflow according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

In some embodiments, an event driven configurable AI workflow is provided to address the issues discussed above. In one embodiment, a system may detect an event (e.g., detect an object) which may trigger execution of an associated series of one or more actions of an application. Each activity or event detected by the system may be identified as a triggering event. An application may require one or more sets of AI models to be executed in response to a particular triggering event dependent upon the specific configuration. The system may be configured and customized into different software applications which can be changed during run-time. For example, additional triggers (i.e., events that act as a trigger) may be added to the workflow, additional activities/AI models may be added to an existing set of activities, and new sets of activities may be added to a triggering event. In one example, an action is added by adding a pointer link to an AI model or action into the workflow.

In one embodiment, in response to sensor data received from a sensor device of a detection device, an analysis is performed on the sensor data within the detection device. The analysis may be performed by applying an AI model to the sensor data. Configuration data is determined based on the analysis of the sensor data. The configuration data identifies one or more actions to be performed. Each action is associated with a particular AI model. For each of the actions, an event is generated to trigger the corresponding action to be performed. In response to each of the events, an AI model corresponding to the action associated with the event is executed. The AI model is applied to at least a portion of the sensor data to classify the sensor data.

In one embodiment, the detection device is one of a number of detection devices disposed at a plurality of geographic locations (e.g., road sides) of a geographic area (e.g., city, metropolitan area, community), as a part of a surveillance system. The configuration data may be retrieved from a storage within the detection device, where the storage stores a number of sets of configuration data corresponding a plurality of detection categories. The configuration data may be stored in a tree data structure having a set of nodes, each node corresponding to an action. A linked list may be generated based on the tree structure representing a workflow of processing the sensor data. The linked list includes a set of nodes and each node contains information identifying at least one AI model to be executed and a processing resource (e.g., processor core) of the detection device used to execute the AI model. The configuration data may be periodically updated from a server over a network during runtime of the detection device.

In one embodiment, in response to detecting that the sensor data contains an image of a human based on the analysis of the sensor data, first configuration data corresponding to the detection of the image of human is identified. The first configuration data includes a first action to determine a face of the human, a second action to determine a gender of the human, and a third action to determine an age of the human. A first AI model, a second AI model, and a third AI model are respectively executed on the image of the human to determine the face, the gender, and the age of the human.

In one embodiment, in response to detecting that the sensor data contains an image of a vehicle based on the analysis of the sensor data, second configuration data corresponding to the detection of the image of a vehicle is identified. The second configuration data includes a first action to determine a type of the vehicle and a second action to determine a model of the vehicle. A first AI model and a second AI model are respectively executed on the image of the vehicle to determine the type of the vehicle and the model of the vehicle.

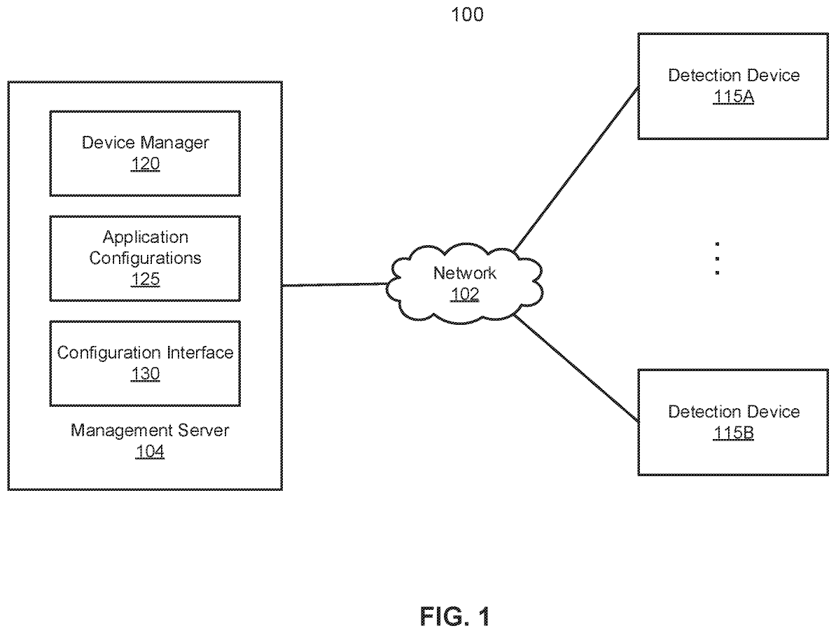

FIG. 1 is a block diagram illustrating an example of a detection system according to one embodiment. For example, system 100 may represent a surveillance system of a geographic area (e.g., city, metropolitan area, community). Referring to FIG. 1, system 100 includes a management server 104, such as a cloud server, communicatively coupled to a set of detection devices 115A-115B (collectively referred to as detection devices 115) over network 102. Network 102 may be a wide area network (WAN) (e.g., Internet), a local area network (LAN), or a combination of both, wired or wireless. Detection devices 115 are also referred to as edge devices, while management server 104 is a cloud server configured to manage detection devices 115.

In one embodiment, each of detection devices 115 is configured to operate based on a set of configuration data specifically configured for the detection device, which can be configured or updated at runtime. Each of detection devices 115 may include at least one sensor device to sense and detect certain objects under different categories or environment. A sensor device may be a camera, a light detection and range (LIDAR) device, a RADAR device, or any other types of image capturing devices.

In one embodiment, each detection device is configured to capture an image and to detect certain content or object (e.g., human, vehicle) in the image according to a workflow set up based on the configuration data stored within the detection device. The configuration data may be downloaded and updated from server 104 over network 102. Dependent upon the detection of a specific object or content, a specific set of configuration data can be determined and a workflow may be generated so that further detection actions can be performed on the image according to the workflow. The actions may be performed by applying certain AI models on the image to classify at least a portion of the content captured by the image under different categories.

In one embodiment, server 104 includes device manager 120, application configurations 125, and configuration interface 130. Configuration interface 130 may be a Web interface, an application programming interface (API), or a command line interface (CLI) to allow an administrator to set up a set of configuration data to be stored as a part of application configurations 125, which may be stored in a storage device within management server 104. An administrator can configure a set of actions to be performed for a particular trigger event, such as, for example, detection of a human or vehicle. Device manager 120 is configured to manage the operations of detection devices 115. In one embodiment, device manager 120 may periodically or on-demand access detection devices 115 to push or download updates of application configurations 125 to detection devices 115. In addition, device manager 120 may upload the detection results (e.g., object classification results) from detection devices 115 over network 102. Server 104 may include other components such as processors, memory, storage device, network interface, etc. that an ordinary computer would include.

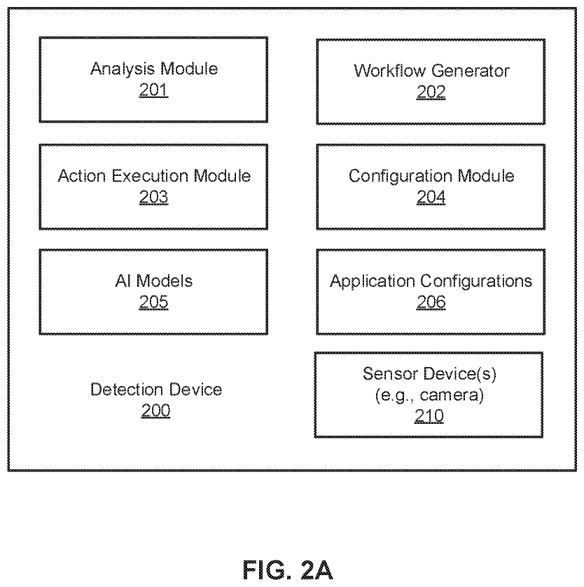

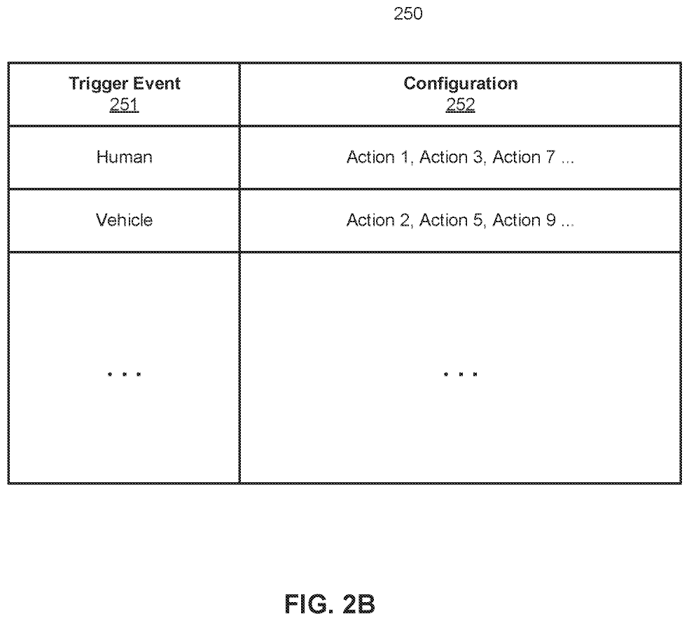

FIG. 2A is a block diagram illustrating an example of a detection device according to one embodiment. For example, detection device 200 may represent any of detection devices 115 of FIG. 1. Referring to FIG. 2, detection device 200 includes one or more sensor devices (or simply sensors) 120, which may be a camera, a LIDAR device, a RADAR device, or any other types of image capturing devices. In one embodiment detection device 200 includes an analysis module 201, a workflow generator 202, action execution module or execution engine 203, and a configuration module 204. Modules 201-204 may be implemented in software, hardware, or a combination thereof.

For example, at least some of the modules 201-204 may be implemented in software, loaded into a memory, and executed by one or more processors of detection device 200. Alternatively, at least some of the modules 201-204 may be integrated into an integrated circuit (IC) such as a field programmable gate array (FPGA) or an application specific integrated circuit (ASIC). AI models 205 may include a variety of AI models for object classification of different purposes. Application configurations 206 may include different configurations for different applications or different purposes, which may be downloaded from management server 104 and periodically updated for new configuration by configuration module 204. AI models 205 and configurations 205 may be stored in a storage device or non-volatile memory of detection device 200 and accessible by at least some of modules 201-204.

In one embodiment, in response to sensor data received from sensor device 210 (e.g., an image), analysis module 201 performs an analysis on the sensor data (e.g., detecting or recognizing a human or vehicle in the image). For example, analysis module 201 may apply an AI model to the sensor data to determine whether the sensor capture an image of a human or a vehicle. In one embodiment, the analysis module may annotate the sensor data to indicate one or more triggers. For example, in response to an image captured by a camera, analysis module 201 may generate and superimpose a bounding box to enclose a person or a vehicle on the image. In one embodiment, each bounding box may trigger a list of one or more actions dependent upon the configuration data associated with the type of content contained within the bounding box. In one embodiment, an image may be annotated having multiple bounding boxes to trigger multiple sets of actions. For example, when detecting a vehicle in an image, one bounding box may be generated to enclose a model name of the vehicle. Another bounding box may enclose a license plate of the vehicle. These two bounding boxes may trigger different sets of actions to determine the vehicle model/manufacturer and the license plate number of the vehicle.

Based on the result of the analysis, workflow generator 202 determines or identifies a set of configuration data associated with the sensor data from the configurations 206. The configuration data may include a set of actions to be performed on at least a portion of the sensor data. Each action may be associated with an AI model stored as a part of AI models 205.

In one embodiment, the configuration data may be stored in a variety of data structures such as a data structure as shown in FIG. 2B. Referring to FIG. 2B, in this example, data structure 250 may be implemented as a mapping table having a number of entries. Each entry maps a trigger event 251 to a particular configuration 252 having a list of one or more actions. Based on the analysis of the sensor data, a trigger event is identified. For example, based on the analysis, it is determined that the sensor data captures a human. Based on the human detection, a trigger event corresponding to the human detection is determined and a lookup operation is performed at table 250 to locate an entry corresponding the human detection. From the entry, actions 1, 3, and 7 may be identified. In one embodiment, the actions of a particular configuration may be stored in a tree structure having a set of nodes. The root node represents a trigger event 251 and the intermediate and leaf nodes represent the actions.

Based on the configuration data, referring back to FIG. 2A, workflow generator 202 generates a workflow describing the actions to be performed on the sensor data. As described above, the workflow is dynamically created based on the configuration, where the configuration may be updated from server 104 at any point in time over network 102.

Based on the workflow, action execution engine 203 is to follow the workflow to execute and to apply the corresponding AI models to the sensor data to classify the sensor data. The workflow may be implemented as a linked list of nodes, each node corresponding to an action to be performed. Each node may include information identify an AI model to be executed and a set of processing resources to be utilized for execution such as processing logic or processor cores, memory, etc. For example, in detecting a person, different AI models may be invoked to determine the gender, race, age, etc. The configuration information may further specify how many processor cores of a processor that will be utilized for gender determination and age, etc. The actions may be performed in sequence or in parallel dependent upon the available processing resources. For each action, an event is generated, which will be handled by an event handler, for example, in an execution thread, to invoke an AI model corresponding to the action. The AI model is then applied to at least a portion of the sensor data to classify the sensor data.

Note that in this configuration, sensor device 210 is implemented within detection device 200. Alternatively, sensor device 210 may be implemented as an external device communicatively coupled to detection device 200. Detection device 200 may be coupled to multiple sensor devices and serves as a local hub device over a local area network, while the detection device 200 is communicatively couple to server 104 over a wider area network. The detection device 200 may be configured to process the sensor data of these sensor devices.

By maintaining the dynamically updateable configuration, the same set of hardware can be utilized to perform different detections required by different applications, without having to change the hardware. A different AI model can be dynamically associated with a particular action dependent upon the specific configuration data at the point in time.

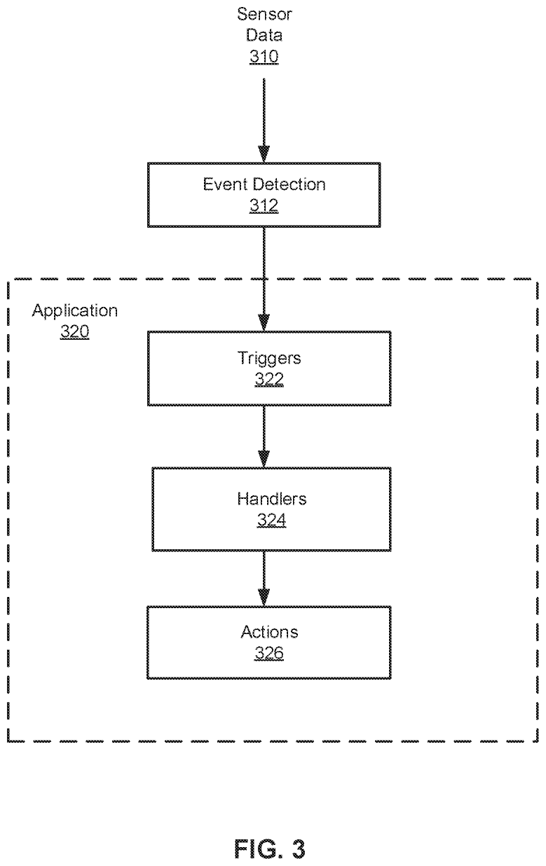

FIG. 3 depicts an example process flow 300 for an event driven configurable AI model workflow. In one embodiment, the process flow 300 includes receiving sensor data 310 from one or more sensors. The sensor data 310 may be images, video, LiDAR data, or any other sensor data for detecting and measuring an environment of a system. The process flow 300 may include event detection 312 using the sensor data 310. Event detection 312 may be performed by an AI model or a detection function. For example, the sensor data 310 may include a signature identifying a particular event that has occurred in the environment detected by the sensor data 310. In another example, an AI model may be applied to the sensor data 310 to detect particular events (e.g., object detection).

An application 320 of the process flow 300 may include triggers 322 that are associated with particular events, handlers 324 to identify actions 326 from the triggers 322. The application 320 may receive the event detection 312 and identify one or more triggers 322 associated with the detected event. Each trigger 322 may be associated with a particular event that may be detected from the sensor data 310. For example, each time the associated event is detected by event detection 312, the particular associated trigger 322 can be identified. In response to a trigger 322 being identified, a handler 324 may be retrieved to identify and perform one or more actions 326. Thus, upon identifying an event, a particular set of actions 326 defined to be executed in response to the event may be executed.

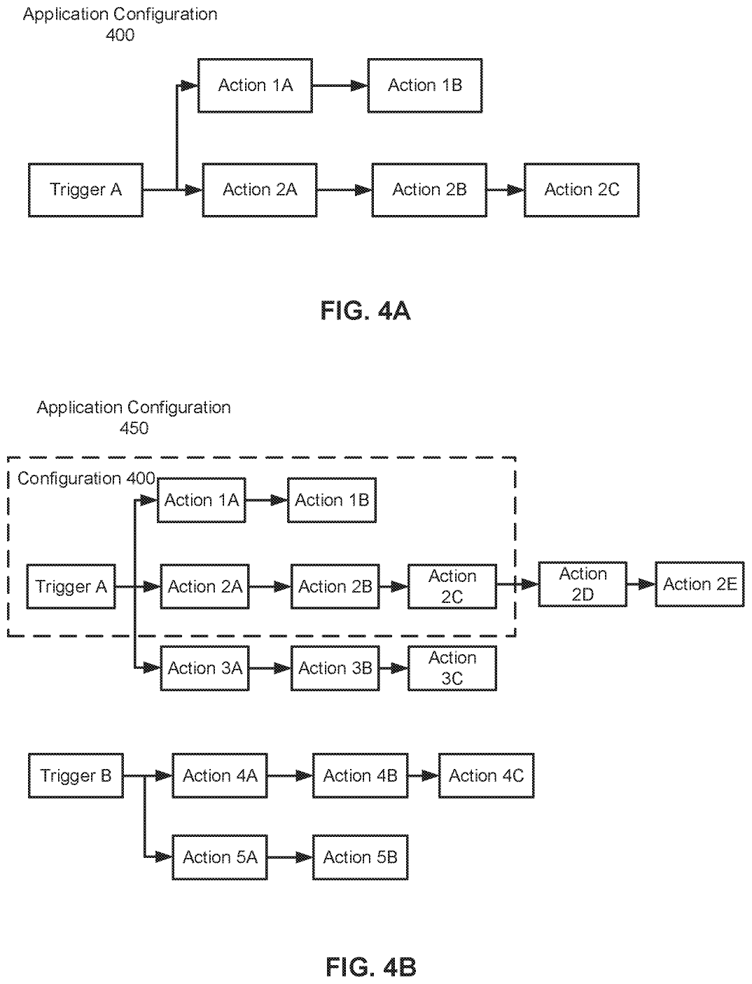

FIG. 4A is an example application configuration 400 for an event driven configurable AI model workflow. The application 400, as depicted, includes a trigger (trigger A) and two sets of actions to be executed in parallel on the system hardware, as described with respect to FIG. 1. Any number of sets of actions may be executed in parallel. Additionally, an application configuration can include any number of triggers. In one embodiment, trigger A may be associated with the detection of an event through application of an AI model to sensor data received from any number of sensors associated with the system. As discussed above, upon detecting the event, processing logic may identify trigger A as associated with the detected event. Trigger A may include a pointer to action 1A (e.g., a first AI model) and a pointer to action 2A (e.g., a second AI model). Thus, action 1A and action 2A may be executed in response to the trigger A. In one embodiment, the application configuration 400 includes one or more queues of pointers to each of the actions to be performed. Accordingly, the queues of pointers may provide for execution of the appropriate actions in response to trigger A.

In another embodiment, action 1A and action 1B are included in a linked list (e.g., a pointer to action 1B may be associated with action 1A, such that after execution of action 1A, action 1B may be identified and executed). Similarly, action 2A, action 2B, and action 2C may be included in separate a linked list. For example, each action may include, or be associated with a pointer to the next action. In another embodiment, the linked list is a series of instructions to be executed sequentially. As described above, an action may be an execution of a particular AI model for classification of the event. In this example, action 1A and action 1B may be associated with different AI models for the same or different classification purposes.

FIG. 4B is another example application configuration 450 of an event driven configurable AI model workflow. FIG. 4B depicts the application configuration 400 as in FIG. 4A with several configuration changes. The application configuration 450 of FIG. 4B includes an additional branch of actions to be performed in response to trigger A and two additional actions linked to the previous action 2C. Furthermore, an additional trigger (trigger B) is added to the application with two branches of actions to be executed in parallel in response to the trigger B. To add an additional trigger, processing logic may associate the trigger with an event. The processing logic may further associate the trigger with instruction pointers to the initial actions to be taken. Processing logic may also generate a linked list for any further actions to be taken. Thus, any changes may easily be made by manipulating the triggers, pointers, and linked lists of actions. These lists of actions may be generated at run time in response to a particular event based on a predetermined configuration associated with a particular application. The configuration of an application may previously be configured by an administrator of the application, which may specify the actions to be performed and the optional execution order of the actions to be performed, etc. The configurations of the applications may be stored in a configuration database.

In one embodiment, the use of triggers and associated linked lists of pointers to the actions to be taken in response to the triggers may provide light weight switching between application configurations (e.g., from application configuration 400 to application configuration 450). For example, system hardware may switch between the application configurations 400 and 450 depending on which application configuration is selected at a given time. Accordingly, the system hardware can operate based on two separate application configurations that can be toggled or selected rather than two application modules executing separately at the same time which may result in slower system performance. Any number of application configurations may be included in a single system to be selected and executed.

In one embodiment, the application configuration 450 may be included in a smart camera of a smart city. The smart camera may be located at an intersection of a road, at a crosswalk, overlooking a sidewalk, or any other location. A smart city may be a collection of interconnected sensing devices (located at different geographic locations within a city or a community) with associated processing devices for processing of sensor data collected by each of the sensing devices. For example, if the smart camera is at an intersection, trigger A may be associated with detection of a vehicle in an image. Actions 1A and 1B may be AI models or functions to identify a type (e.g., sedan, SUV, truck), a vehicle color, vehicle model/manufacturer, or license plate, etc. Actions 2A-E may be models to determine motion characteristics of the vehicle such as velocity, acceleration, jerk, whether the vehicle is under control, and so forth. Actions 3A-C may be AI models or functions to determine any number of additional characteristics of the detected vehicle.

In another example, trigger B may be associated with detecting a person in an image. Actions 4A-C may be associated with detecting whether the detected person is safe at the intersection. For example, actions 4A-C may determine whether a stoplight at the intersection is green or red, a direction of motion of traffic at the intersection, etc. Actions 5A-B may detect characteristics of the detected person. For example, actions 5A-B may be AI models to detect an age, gender, or other details of the detected person. In one embodiment, additional actions may further detect features such as emotion, groups of people, or any other information about the detected person or people in images obtained by the smart camera.

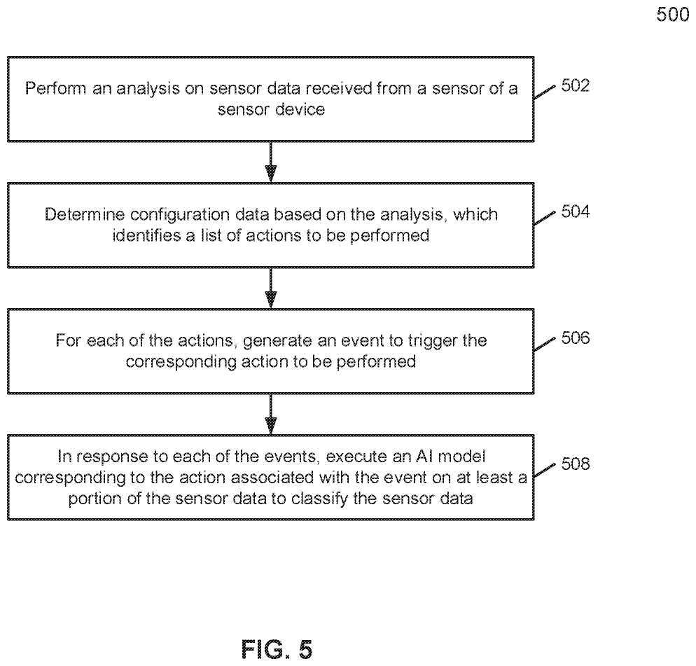

FIG. 5 depicts an example method 500 of implementing an event driven configurable AI model workflow, according to one embodiment. Method 500 may be performed by processing logic which may include software, hardware, or a combination thereof. For example, method 500 may be performed by a detection device as described above.

Referring to FIG. 5, at block 502, in response to sensor data (e.g., image) obtained from a sensor device (e.g., camera), processing logic performs an analysis (e.g., image recognition) on the sensor data. In one embodiment, the analysis may be performed by applying an AI model on the image, for example, to determine whether the image contains a human or a vehicle, etc. Based on the analysis, at block 504, processing logic determines configuration data associated with a trigger as a result of the analysis (e.g., detection of a person or a vehicle). The configuration data includes a list of actions to be performed. At block 506, for each of the actions, processing logic generates an event which trigger the corresponding action to be performed. In response to each of the events, at block 508, an AI model corresponding to the action associated with the event is executed on at least a portion of the sensor data to classify the sensor data.

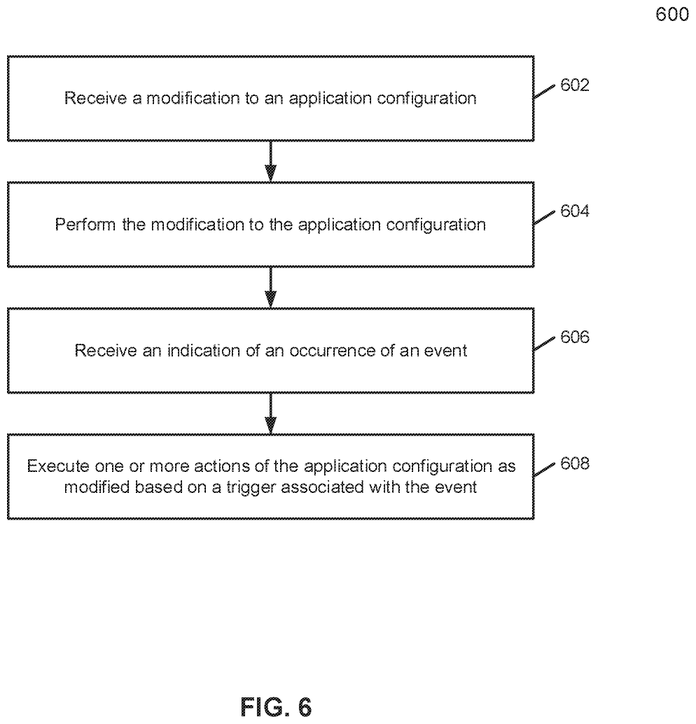

FIG. 6 depicts a flow diagram for another method 600 of implementing an event driven configurable AI model workflow, according to one embodiment. Method 600 may be performed by processing logic which may include software, hardware, or a combination thereof. For example, method 600 may be performed by hardware executing event driven AI workflow module 120 of FIG. 1.

At block 602, processing logic receives a modification to an application configuration. The application may include a set of triggers (i.e., detected events which trigger performance of an action) along with one or more actions to be performed in response to the trigger. The triggers and the one or more actions may be configurable by a user (e.g., a system administrator). The modification to the application configuration may include additional of or removal of one or more triggers and additional or removal of actions (e.g., AI models) associated with the triggers of the application. At block 604, processing logic performs the configuration changes for the application configuration. The processing logic may update one or more linked list of instruction pointers based on the modifications to the application. Therefore, additional actions can be linked to other actions in the configuration by modifying the linked list of pointers to include the additional actions.

At block 606, processing logic receives an indication of an occurrence of an event. The event may be a pattern recognized by the processing logic. For example, the event may be an object detection, recognition of a certain circumstance, or other environmental events detectable by any type of sensor. At block 608, processing logic executes one or more actions of the application configuration as modified based on a trigger associated with the event.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A method of operating a detection device, comprising:
in response to sensor data received from a sensor device of the detection device, performing an analysis on the sensor data within the detection device;
determining configuration data based on the analysis of the sensor data, the configuration data identifying a plurality of actions to be performed, wherein each action is associated with a particular artificial intelligence (AI) model;
for each of the actions, generating an event to trigger the corresponding action to be performed; and
in response to each of the events, executing an AI model corresponding to the action associated with the event, the AI model being applied to at least a portion of the sensor data to classify the sensor data.

2. The method of claim 1, wherein the detection device is one of a plurality of detection devices disposed at a plurality of geographic locations of a geographic area.

3. The method of claim 1, further comprising retrieving the configuration data from a storage within the detection device, wherein the storage stores a plurality of sets of configuration data corresponding a plurality of detection categories.

4. The method of claim 3, wherein the configuration data is stored in a tree structure having a plurality of nodes, each node corresponding to an action.

5. The method of claim 4, further comprising generating a linked list based on the tree structure representing a workflow of processing the sensor data, wherein the linked list includes a plurality of nodes, each node contains information identifying an AI model to be executed and a processing resource of the detection device used to execute the AI model.

6. The method of claim 3, further comprising periodically receiving updates of the configuration data from a server over a network during runtime of the detection device.

7. The method of claim 1, further comprising:
detecting that the sensor data contains an image of a human based on the analysis of the sensor data;
identifying first configuration data corresponding to the detection of the image of human, the first configuration data including a first action to determine a face of the human, a second action to determine a gender of the human, and a third action to determine an age of the human; and
executing a first AI model, a second AI model, and a third AI model respectively on the image of the human to determine the face, the gender, and the age of the human.

8. The method of claim 1, further comprising:
detecting that the sensor data contains an image of a vehicle based on the analysis of the sensor data;
identifying second configuration data corresponding to the detection of the image of a vehicle, the second configuration data including a first action to determine a type of the vehicle and a second action to determine a model of the vehicle; and
executing a first AI model and a second AI model respectively on the image of the vehicle to determine the type of the vehicle and the model of the vehicle.

9. A non-transitory machine-readable medium having instructions stored therein, which when executed by a processor, cause the processor to perform operations of operating a detection device, the operations comprising:
in response to sensor data received from a sensor device of the detection device, performing an analysis on the sensor data within the detection device;
determining configuration data based on the analysis of the sensor data, the configuration data identifying a plurality of actions to be performed, wherein each action is associated with a particular artificial intelligence (AI) model;
for each of the actions, generating an event to trigger the corresponding action to be performed; and
in response to each of the events, executing an AI model corresponding to the action associated with the event, the AI model being applied to at least a portion of the sensor data to classify the sensor data.

10. The machine-readable medium of claim 9, wherein the detection device is one of a plurality of detection devices disposed at a plurality of geographic locations of a geographic area.

11. The machine-readable medium of claim 9, wherein the operations further comprise retrieving the configuration data from a storage within the detection device, wherein the storage stores a plurality of sets of configuration data corresponding a plurality of detection categories.

12. The machine-readable medium of claim 11, wherein the configuration data is stored in a tree structure having a plurality of nodes, each node corresponding to an action.

13. The machine-readable medium of claim 12, wherein the operations further comprise generating a linked list based on the tree structure representing a workflow of processing the sensor data, wherein the linked list includes a plurality of nodes, each node contains information identifying an AI model to be executed and a processing resource of the detection device used to execute the AI model.

14. The machine-readable medium of claim 11, wherein the operations further comprise periodically receiving updates of the configuration data from a server over a network during runtime of the detection device.

15. The machine-readable medium of claim 9, wherein the operations further comprise:
detecting that the sensor data contains an image of a human based on the analysis of the sensor data;
identifying first configuration data corresponding to the detection of the image of human, the first configuration data including a first action to determine a face of the human, a second action to determine a gender of the human, and a third action to determine an age of the human; and
executing a first AI model, a second AI model, and a third AI model respectively on the image of the human to determine the face, the gender, and the age of the human.

16. The machine-readable medium of claim 9, wherein the operations further comprise:
detecting that the sensor data contains an image of a vehicle based on the analysis of the sensor data;
identifying second configuration data corresponding to the detection of the image of a vehicle, the second configuration data including a first action to determine a type of the vehicle and a second action to determine a model of the vehicle; and
executing a first AI model and a second AI model respectively on the image of the vehicle to determine the type of the vehicle and the model of the vehicle.

17. A detection device, comprising:
a sensor device;
processing logic; and
a memory coupled to the processing logic to store instructions, which when processed by the processing logic, cause the processing logic to perform operations, the operations including
in response to sensor data received from the sensor device, performing an analysis on the sensor data,
determining configuration data based on the analysis of the sensor data, the configuration data identifying a plurality of actions to be performed, wherein each action is associated with a particular artificial intelligence (AI) model,
for each of the actions, generating an event to trigger the corresponding action to be performed, and
in response to each of the events, executing an AI model corresponding to the action associated with the event, the AI model being applied to at least a portion of the sensor data to classify the sensor data.

18. The device of claim 17, wherein the detection device is one of a plurality of detection devices disposed at a plurality of geographic locations of a geographic area.

19. The device of claim 17, wherein the operations further comprise retrieving the configuration data from a storage within the detection device, wherein the storage stores a plurality of sets of configuration data corresponding a plurality of detection categories.

20. The device of claim 19, wherein the configuration data is stored in a tree structure having a plurality of nodes, each node corresponding to an action.
